(19) United States
(12) Patent Application Publication
(10) Pub. No.: US 2014/0069562 A1
(43) Pub. Date: Mar. 13, 2014

(54) AERODYNAMIC BICYCLE TIRE

(71) Applicant: James Michael FELT, Auburn, CA (US)

(72) Inventor: James Michael FELT, Auburn, CA (US)

(21) Appl. No.: 13/609,620

(22) Filed: Sep. 11, 2012

(51) Int. Cl. B60C 13/02

(52) U.S. Cl. CPC B60C 13/02
USPC 152/523

(57) ABSTRACT

Provided is a bicycle tire for use with a bicycle wheel. The bicycle tire includes a tire body defining a closed loop and being configured to be engagable with the bicycle wheel. The tire body defines an outer periphery and includes an exposed portion extending radially outward from the bicycle wheel when engaged therewith. The exposed portion is externally configured to define a partial, non-circular ellipse in a cross sectional plane perpendicular to the tangent of the outer periphery. The partial ellipse includes a closed end portion at the outer periphery and an open end portion adjacent the bicycle wheel. A plurality of nubs is attached to the tire body, with the nubs being configured to remain attached thereto during the life of the bicycle tire. The nubs are sized and configured to enhance the aerodynamics of the bicycle tire as the tire rotates and translates through a fluid.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND OF THE INVENTION

1. Technical Field of the Invention

The present invention relates generally to a bicycle tire and more specifically to a bicycle tire configured and adapted to have superior aerodynamic characteristics designed to mitigate wind resistance and drag.

2. Description of the Related Art

Bicycles are widely used in all corners of the world. A bicycle may be employed as a general means of transportation, or alternatively, as a recreational device, wherein the rider utilizes the bicycle for purposes of enjoyment or exercise. The structure of a bicycle generally includes a frame and a pair of wheels connected to the frame. Each wheel is fitted with a tire, which extends circumferentially about the wheel, and provides traction with the riding surface (i.e., track, road, etc.).

One aspect of bicycle riding which has a direct effect on the performance of the bicycle is the aerodynamic drag created as the bicycle and the rider pass through the air. In particular, the aerodynamic drag caused by the bicycle and the rider lessens the speed obtainable for the cyclist for the effort expended in propelling the bicycle. At average speeds, aerodynamic drag is typically the largest resistive force acting on the bicycle, aside from the gravity of a large hill.

Bicycle designers and riders recognize the detrimental effect caused by aerodynamic drag, and thus, certain measures have been taken to reduce drag. One particular improvement for enhancing aerodynamic performance has been the recognition that the human body is not very streamlined, and therefore, body positioning has a critical impact on the aerodynamics. To this end, road cyclists commonly employ “drop bars” to allow themselves to reduce their frontal area, which helps reduce the amount of resistance they must overcome. In addition to cyclist positioning, other details, such as clothing, can make a significant impact in reducing “skin friction.” Tight-fighting clothing is worn by most cyclists for improvement in aerodynamics, as well as comfort.

In addition to improving the aerodynamics of the rider, other features have been implemented into contemporary bicycle designs to minimize the amount of drag created by the bicycle itself. Some recent frame designs have concentrated on creating a more streamlined frame design. Designers have also attempted to improve the aerodynamics of the bicycle wheels. Along these lines, a conventional spoked wheel creates many small eddies as the wheel rotates, which increases the drag. Thus, disc-wheels are often use, which produce less wind drag and turbulence as they spin.

One particular area of the bicycle which has not been given much consideration for its aerodynamic impact is the bicycle tire. In view of the fact that the bicycle tire circumnavigates the wheel, the bicycle tire defines a leading edge which directly interfaces with the air as the bicycle moves. Thus, the tire has an immediate impact on the overall aerodynamics of the bicycle.

Most conventional tires define a generally circular outer surface taken within at least one cross section. In this regard, the generally circular outer surface defines a generally constant radius about a central axis. As the tire passes through the air, the generally circular outer surface separates the air into two separate, diverging air flows. The divergent nature of the separate air flows increases the wind resistance and drag on the bicycle, and thus, reduces the overall aerodynamics thereof.

Therefore, there is a need in the art for an improved bicycle tire designed to have reduced drag and wind resistance relative to conventional bicycle tires. Various aspects of the present invention address these particular needs, as will be discussed in more detail below.

### BRIEF SUMMARY OF THE INVENTION

The present invention specifically addresses and alleviates the above-identified deficiencies in the art. Along these lines, there is provided a bicycle tire for use with a bicycle wheel. The bicycle tire includes a tire body defining a closed loop and being configured to be engagable with the bicycle wheel. The tire body defines an outer periphery and includes an exposed portion extending radially outward from the bicycle wheel when engaged therewith. The exposed portion is externally configured so as to define a partial, non-circular ellipse in a cross sectional plane perpendicular to the tangent of the outer periphery. The partial ellipse includes a closed end portion at the outer periphery and an open end portion adjacent the bicycle wheel. The tire includes separately, or in combination with the aforementioned tire body, a plurality of nubs attached to the tire body, with the nubs being configured to remain attached thereto during the life of the bicycle tire. The nubs are sized and configured to enhance the aerodynamics of the bicycle tire as the tire rotates and translates through a fluid.

The unique external configuration of the bicycle tire provides improved aerodynamic qualities relative to conventional bicycle tires. Along these lines, the oblong, elliptical shape of the tire body allows the tire body to slice through the air to minimize disruption of the air, which in turn reduces drag and wind resistance. The placement and configuration of the nubs provides additional aerodynamic benefits to the bicycle tire.

The plurality of nubs may be integrally formed with the tire body. The exposed portion may include a first lateral portion and an opposing second lateral portion, wherein the plurality of nubs may include a plurality of first nubs connected to a first lateral portion of the tire body and a plurality of second numbs connected to the second lateral portion of the tire body. The plurality of first nubs may be equally spaced relative to each other, and the plurality of second nubs may be equally spaced relative to each other. The plurality of nubs may be angled relative to the tire body toward the outer periphery as the nubs extend away from the tire body.

The closed end portion may terminate at a distal end, such that the exposed portion may define a cross sectional length equal to the distance between the wheel and the distal end, and a cross sectional width equal to the maximum distance between opposed lateral ends of the exposed portion, wherein the cross sectional length is greater than the cross sectional width. The exposed end portion may define a variable cross sectional radius of curvature in the cross section taken in a plane perpendicular to the tangent of the outer periphery. The radius of curvature may be greatest along a first axis which divides the closed end portion into two symmetrical halves, and shortest along a second axis perpendicular to the first axis.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a side view of a pair of tires constructed in accordance with an embodiment of the present invention, wherein a bicycle frame and rider are depicted in phantom;

FIG. 2 is a partial upper perspective cross sectional view of the tire depicted in FIG. 1, wherein the cross section is taken in a plane perpendicular to the tangent of the tire;

FIG. 3 is a partial upper perspective cross sectional view of a prior art tire, wherein the cross section is taken in a plane perpendicular to the tangent of the tire;

FIG. 4 is a top view of the prior art cross section depicted in FIG. 3, including several lines depicted in phantom representative of a fluid flow around the prior art tire; and

FIG. 5 is a top view of the cross section depicted in FIG. 2, including several lines depicted in phantom representative of a fluid flow around the tire.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for purposes of illustrating a preferred embodiment of the present invention, and not for purposes of limited the same, there is shown a bicycle tire 10 constructed in accordance with an embodiment of the present invention. The bicycle tire 10 is specifically configured and adapted to have improved aerodynamic characteristics, particularly when compared to conventional bicycle tires, wherein the improved aerodynamics yields a reduced drag and wind resistance. As will be described in more detail below, the primary structural features which contribute to the improved tire aerodynamics are the elliptical shaped cross-section of the tire 10 (see FIGS. 2 and 4), as well as the plurality of nubs, i.e., aerodynamic trips, 14 protruding from the tire 10. These features allow the tire 10 to slice through the air to minimize the amount of displacement of the air flowing around the tire 10.

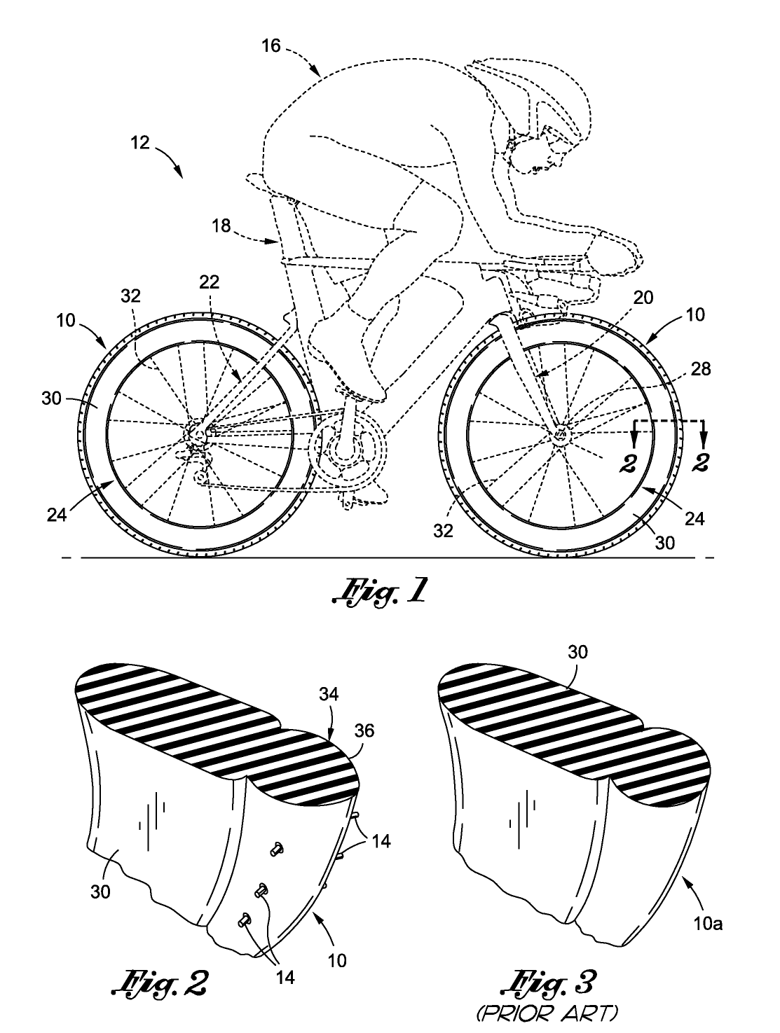

Referring now specifically to FIG. 1, there is shown a rider 16 on bicycle 12 outfitted with a bicycle tire 10 constructed in accordance with an embodiment of the present invention. The bicycle 12 is partially shown in phantom and includes a conventional bicycle frame 18 having front and rear forks 20, 22. Each fork 20, 22 is engaged to a wheel 24 in a manner which allows the wheel 24 to rotate about a respective axis of rotation.

Each wheel 24 includes a central hub 28 connected to a peripheral rim 30 via a plurality of spokes 32 which extend radially between the rim 30 and the hub 28. Each wheel 24 defines a respective axis of rotation about which the hub 28 and rim 30 are disposed and rotate. The rim 30 defines an inner diameter and an outer diameter. According to one embodiment, the rim 30 defines a conventional U-shape including a closed end portion adjacent the inner diameter and an open end portion adjacent the outer diameter (not shown). The open end portion defines a rim slot extending around the outer circumference of the rim 30 and configured to facilitate engagement with the tire 10.

The bicycle 12 includes a pair of tires 10 engaged with respective ones of the front and rear wheels 24, wherein each tire 10 includes a tire body 34 (See FIG. 2) defining a continuous loop. Each tire 10 is configured to be engageable with the rim 30 of a respective one of the wheels 24. According to one embodiment, the tire body 34 is a “clincher-type” tire that includes an engagement portion that engages with the wheel rim 30, wherein the engagement portion includes a pair of engagement beads that extend into the rim slot (not shown). When the tire 10 is inflated, the inner pressure of the tire 10 urges the engagement bead into engagement with the rim 30 so as to secure the tire 10 to the rim 30. Another embodiment of the tire 10 may include a “tubular tire” or “sew-up” tire having a cotton or fabric strip attached to the tire body 34. The cotton or fabric strip may then be glued to the rim 30 to secure the tire 10 thereto.

When the tire body 34 is engaged with the wheel 24, the tire body 34 defines an exposed portion 36 (see FIGS. 2 and 5) that protrudes radially outward from the rim 30 and is uniquely configured to achieve improved aerodynamics relative to conventional tires. As used herein, the exposed portion 36 is defined as the portion of the tire body 34 that interfaces with the surrounding air during movement of the bicycle 12. Along these lines, the exposed portion 36 defines a unique external configuration which is configured to mitigate wind resistance caused by rotation of the tire 10 and lateral movement of the bicycle 12.

Referring now specifically to FIG. 2, there is shown a partial, upper perspective view of the wheel 24 and tire 10. As noted above, various aspects of the present invention are directed to the advantageous external configuration of the tire 10, and thus, the inside of the wheel 24 and tire 10 are not critical aspects of the present invention. Thus, the inside of the wheel 24 and tire 10 are generally represented with cross-hatching in FIG. 2. Those skilled in the art will recognize that the cross-hatching is a general representation of the inside of the wheel 24 and tire 10, and does not limit the scope of the present invention. In this regard, it is understood that various implementations of the wheel 24 and/or the tire 10 may include hollow portions, cavities, or the like to allow for inflation of the tire 10 without departing from the spirit and scope of the present invention.

The external surface of the exposed portion 36 defines a non-circular, partial elliptical shape in a cross section taken within a plane that is perpendicular to the tangent of the outer periphery of the tire body 34. The partial elliptical shape defines a variable radius of curvature which produces the non-circular configuration. The exposed portion 36 includes a closed end portion defining a generally parabolic shape adjacent an outer periphery of the tire body 34, and an open end portion disposed adjacent the rim 30 when the tire body 34 is engaged to the rim 30. In this regard, the cross section of the exposed portion 36 does not form a complete, closed ellipse.

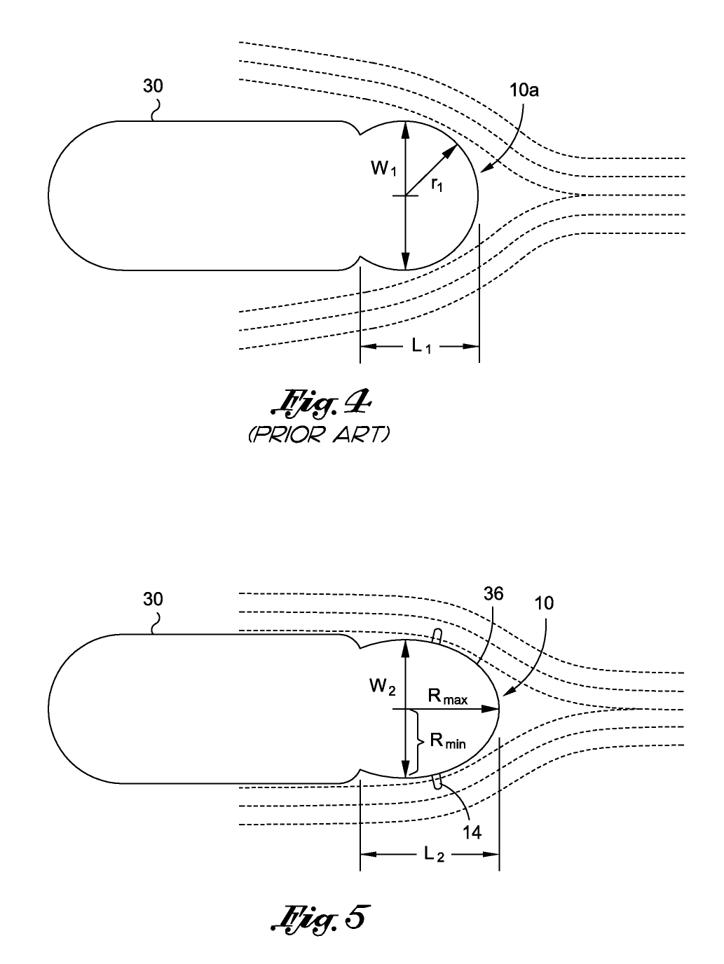

The aerodynamic benefits realized by the tire 10 are at least partially attributable to the non-circular partial elliptical shape of the exposed portion 36 of the tire body 34. For purposes of comparison, reference is now made to FIGS. 3 and 4, which depict a cross section of a prior art tire 10a. FIG. 3 shows a cross section of the prior art tire 10a taken in a similar plane to that shown in FIG. 2 (i.e., a plane that is perpendicular to the tangent of the tire 10a). The prior art tire 10a is coupled to the rim 30 of a wheel, such that the prior art tire 10a defines an exposed portion which protrudes from the wheel rim 30. The exposed portion defines partial circular configuration, wherein the exterior surface of the exposed portion extends about a common axis to define a constant radius, “r₁” (see FIG. 4). The dimensional characteristics of the exposed portion of the prior art tire 10a may be characterized in terms of a length, “L₁,” and a width, “W₁” (see FIG. 4). The length L₁ is defined as the maximum distance which the exposed portion extends from the wheel rim, 30 while the width, W₁ is defined as the maximum distance between the diametrically opposed lateral bounds of the exposed portion. In effect, the width W₁ of the circular prior art tire 10a is equal to twice the radius R₁ (or the diameter of the circle, if the circle were complete).

The circular configuration of the prior art tire 10a creates an aerodynamic effect which pushes fluid away from the tire 10a as the tire 10a passes through the fluid. The phantom lines shown in FIG. 4 depict the flow path of the fluid around the prior art tire 10a. As can be seen, as the tire 10a passes through the fluid, it separates the fluid into two separate, diverging flow paths, wherein the separate flow paths extend away from each other along generally non-parallel axes. In other words, the amount of separation of the fluid flow paths downstream of the tire 10a is generally greater than the width W₁ defined by the tire 10a. Therefore, the configuration of the prior art tire 10a creates a “plowing” effect as the tire 10a passes through the air.

Conversely, various aspects of the present invention are directed toward creating an improved aerodynamic condition which mitigates the degree of fluid separation as the tire 10 advances through the surrounding fluid, i.e., air. Turning now to FIG. 5, which depicts a tire 10 constructed in accordance with an embodiment of the present invention, the fluid flow paths created by tire 10 movement through the fluid are not as divergent as the flow paths depicted in FIG. 4. In particular, as the tire 10 advances through the fluid, the fluid is separated into two separate flow paths, which generally conform to the lateral end portions of the tire 10 and flow in a generally parallel directions downstream of the tire 10. As such, the wind resistance and drag associated with the tire is minimized relative to conventional bicycle tires.

The beneficial aerodynamic characteristics are at least partially attributable to the unique configuration of the tire body 34. More specifically, the exposed portion 36 of the tire body 34 is a non-circular, elliptical shape wherein the magnitude of the radius of curvature from the center of the ellipse varies. In the exemplary embodiment shown in FIG. 5, a maximum radius, “Rₘₐₓ,” is shown extending along a longitudinal axis of the tire body 36, and a minimum radius, “Rₘᵢₙ,” is shown extending along a latitudinal axis of the tire body 36, wherein Rₘₐₓ is greater than Rₘᵢₙ. The tire body 36 additionally defines a width, “W₂,” as the maximum distance between the opposed lateral bounds of the exposed portion 36, which is substantially equal to twice the Rₘᵢₙ, and a length, “L₂,” as the distance between the distal end of the exposed portion 36 and the wheel rim 30. In one embodiment, the length L₂ is greater than the width W₂.

As can be seen, as the tire 10 is advanced through the fluid, the fluid separates into two separate, but parallel flow paths, wherein the space between the flow paths is substantially equal to the width W₂. The unique configuration of the exposed portion 36 of the tire body 34 minimizes the amount of displacement of the fluid flow paths, which results in a beneficial aerodynamic effect.

Another beneficial aerodynamic feature of at least one embodiment of the tire 10 relates to the plurality of nubs 14 connected to the exposed portion 36. The nubs 14 may be coupled to one, but preferably both sides or lateral portions of the exposed portion 36 of the tire body 34 and may be spaced adjacent the circumference of the tire body 34. In the embodiment shown in FIGS. 1 and 2, the nubs 14 are equally spaced on both sides of the tire body 34. The number of nubs 14 may be varied without departing from the spirit and scope of the present invention. It is additionally contemplated that the nubs 14 may be arranged in a specific configuration to define a desired appearance, such as a logo or trademark associated with the tire manufacturer.

The nubs 14 may be specifically configured and adapted to remain connected to the tire body 34 throughout the normal life of the tire 10. According to one embodiment, the nubs 14 may be integrally formed to the tire body 34 through a molding process. More specifically, the mold may define a cavity which substantially conforms to the size and shape of the tire body 34, such that when a molding material is poured or transferred into the mold cavity, the molding material assumes the shape of the tire body 34. The mold may additionally include a plurality of vent holes connected to and extending from the mold cavity, wherein the vent holes are configured to prevent the formation of air bubbles within the molded tire body 34. In particular, as the molding material fills up the mold cavity, the vent holes allow air to escape the mold cavity. When the mold cavity is filled, the excess molding material bleeds into the vent holes and forms the plurality of nubs 14. Thus, when the molding material hardens, the nubs 14 are integrally formed with the tire body 34.

The nubs 14 may also be formed through transfer holes used in the molding process. In particular, the molding process may utilize a mold and a reservoir of rubber material, wherein the rubber material is transferred from the reservoir into the mold via a plurality of transfer holes. The nubs 14 may be formed from excess rubber material contained within the transfer holes at the end of the molding process.

According to one embodiment, the nubs 14 extend out from the tire body 34 and are angled toward the outer circumference of the tire body 34, although it is understood that the particular orientation of the nubs 14 is not limited thereto. In this regard, the nubs 14 may extend from the tire body 34 along a common axis in opposed directions, or toward the inner circumference of the tire body 34. Furthermore, the length, diameter, and shape of the nubs 14 may be varied to enhance the aerodynamic effect created thereby. In this regard, the nubs 14 are not limited to the particular round/cylindrical configuration depicted in the figures; other embodiments may include nubs 14 that are triangular, quadrangular, etc. Moreover, the size of the nubs 14 may be increased to provide more structural rigidity to ensure the nubs 14 remain connected to the tire body 34 during the normal life of the tire 10, under normal operating conditions.

The various structural attributes, including the partial elliptical, non-circular shape of the tire body 34, as well as the plurality of nubs 14, may be used on any size or diameter of wheel 24. Furthermore, it is also understood that other aerodynamic enhancement features may be incorporated into the tire 10. For instance, the tread formed on the tire 10 may define a specific configuration which enhances the aerodynamics of the tire 10 by minimizing the degree of separation of the fluid flow paths around the tire 10. Along these lines, the tread design may be integrated into the desirable elliptical shape of the tire body 34.

Furthermore, although the foregoing discussion and the related drawings pertain to an embodiment of the tire 10 including both an elliptical, non-circular shape, as well as a plurality of nubs 14, it is understood that other embodiments may include one or the other, not necessarily in combination with each other. More specifically, one embodiment may include a plurality of nubs 14 on a tire 10 that does not define a non-circular elliptical shape, while another embodiment of the tire 10 may define a non-circular elliptical shape, without a plurality of nubs 14.

Although foregoing describes a bicycle tire, it is contemplated that other aspects of the present invention may relate to other types of tires for other wheeled devices, including but not limited to, unicycles, wheelchairs, motorcycles, automobiles, tractors, go-carts or the like.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A bicycle tire for use with a bicycle wheel, the bicycle tire comprising:
a tire body defining a closed loop and being configured to be engagable with the bicycle wheel, the tire body defining an outer periphery and having an exposed portion extending radially outward from the bicycle wheel when engaged therewith, the exposed portion being externally configured so as to define a partial, non-circular ellipse in a cross section taken in a plane perpendicular to the tangent of the outer periphery, the partial ellipse having a closed end portion at the outer periphery and an open end portion adjacent the bicycle wheel; and
a plurality of nubs attached to the tire body and configured to remain attached thereto during the life of the bicycle tire, the plurality of nubs being sized and configured to enhance the aerodynamics of the bicycle tire as the tire rotates and translates through a fluid.

2. The bicycle tire recited in claim 1, wherein the plurality of nubs is integrally formed with the tire body.

3. The bicycle tire recited in claim 1, wherein the exposed portion includes a first lateral portion and an opposing second lateral portion, the plurality of nubs including a plurality of first nubs connected to a first lateral portion of the tire body and a plurality of second numbs connected to the second lateral portion of the tire body.

4. The bicycle tire recited in claim 3, wherein the plurality of first nubs is equally spaced relative to each other.

5. The bicycle tire recited in claim 4, wherein the plurality of second nubs is equally spaced relative to each other.

6. The bicycle tire recited in claim 1, wherein the plurality of nubs is angled relative to the tire body toward the outer periphery as the nubs extend away from the tire body.

7. The bicycle tire recited in claim 1, wherein the closed end portion terminates at a distal end, the exposed portion defining a cross sectional length equal to the distance between the wheel and the distal end, and a cross sectional width equal to the maximum distance between opposed lateral ends of the exposed portion, the cross sectional length being greater than the cross sectional width.

8. The bicycle tire recited in claim 1, wherein the exposed end portion defines a variable cross sectional radius of curvature in the cross section taken in a plane perpendicular to the tangent of the outer periphery.

9. A bicycle tire for use with a bicycle wheel, the bicycle tire comprising:
a tire body defining a closed loop and being configured to be engagable with the bicycle wheel, the tire body defining an outer periphery and having an exposed portion extending radially outward from the bicycle wheel when engaged therewith, the exposed portion being externally configured so as to define a partial, non-circular ellipse in at least one cross sectional plane, the partial ellipse having a closed end portion at the outer periphery and an open end portion adjacent the bicycle wheel; and

10. The bicycle tire recited in claim 9, wherein the closed end portion terminates at a distal end, the exposed portion defining a cross sectional length equal to the distance between the wheel and the distal end, and a cross sectional width equal to the maximum distance between opposed lateral ends of the exposed portion, the cross sectional length being greater than the cross sectional width.

11. The bicycle tire recited in claim 9, wherein the exposed end portion defines a variable cross sectional radius of curvature in the cross section taken in a plane perpendicular to the tangent of the outer periphery.

12. The bicycle tire recited in claim 11, wherein the radius of curvature is greatest along a first axis which divides the closed end portion into two symmetrical halves, and shortest along a second axis perpendicular to the first axis.

13. A bicycle tire for use with a bicycle wheel, the bicycle tire comprising:
a tire body defining a closed loop and being configured to be engagable with the bicycle wheel, the tire body defining an outer periphery and having an exposed portion extending radially outward from the bicycle wheel when engaged therewith; and
a plurality of nubs attached to and extending outwardly from the tire body, the plurality of nubs being configured to remain attached thereto during the life of the bicycle tire, and to enhance the aerodynamics of the bicycle tire as the tire rotates and translates through a fluid.

14. The bicycle tire recited in claim 13, wherein the plurality of nubs is integrally formed with the tire body.

15. The bicycle tire recited in claim 13, wherein the exposed portion includes a first lateral portion and an opposing second lateral portion, the plurality of nubs including a plurality of first nubs connected to a first lateral portion of the tire body and a plurality of second numbs connected to the second lateral portion of the tire body.

16. The bicycle tire recited in claim 15, wherein the plurality of first nubs is equally spaced relative to each other.

17. The bicycle tire recited in claim 16, wherein the plurality of second nubs is equally spaced relative to each other.

18. The bicycle tire recited in claim 13, wherein the plurality of nubs are angled relative to the tire body toward the outer periphery as the nubs extend away from the tire body.

19. The bicycle tire recited in claim 13, wherein the exposed portion of the tire body defines a closed end portion terminating at a distal end, the exposed portion defining a cross sectional length equal to the distance between the wheel and the distal end, and a cross sectional width equal to the maximum distance between opposed lateral ends of the exposed portion, the cross sectional length being greater than the cross sectional width.

20. The bicycle tire recited in claim 13, wherein the exposed end portion defines a variable cross sectional radius of curvature in at least one cross sectional plane.
